(19) United States
(12) Patent Application Publication
(10) Pub. No.: US 2020/0343023 A1
(43) Pub. Date: Oct. 29, 2020

(54) SELF-CLOSING FOIL SHEATHING AND METHOD OF MAKING THE SAME

(71) Applicant: LEONI KABEL GMBH, Roth (DE)

(72) Inventors: ARNO FRAHMANN, Kleefeld (DE); BERND JANSSEN, Friesoythe (DE)

(21) Appl. No.: 16/765,001

(22) PCT Filed: Nov. 7, 2018
(86) PCT No.: PCT/EP2018/080454

§ 371 Date: May 18, 2020

(30) Foreign Application Priority Data
Nov. 23, 2017 (DE) 10 2017 220 919.4

(51) Int. Cl. H01B 13/26; G02B 6/44; H01B 11/10

(52) U.S. Cl. CPC H01B 13/26; H01B 11/1008; H01B 11/1025; G02B 6/4486

(57) ABSTRACT

A method for producing a self-closing foil sheathing (14) wound onto at least one line (10) of a cable arrangement (12) includes providing an elastically deformable foil strip (16) which, in a load-free or bare state, is bent in a plane of the foil strip (16). The foil strip (16) is wound onto the line (10) in order to form the foil sheathing (14) which surrounds the line (10). The foil strip (16) during winding onto the line (10) is elastically deformed radially to the outside and in this way is subjected to radial loading in the direction of the line (10).

### RELATED APPLICATION

This application filed under 35 U.S.C § 371 is a national phase application of International Application Serial Number PCT/EP2018/080454 filed Nov. 7, 2018, which claims priority to German Patent Application No. 10 2017 220 919.4 filed on Nov. 23, 2017, the entirely of which are incorporated herein by reference.

### TECHNICAL FIELD

The disclosure relates to a method for producing a self-closing foil sheathing which is wound on at least one conductor of a cable arrangement, and to a cable arrangement comprising such a foil sheathing. The disclosure relates further to a shaping tool for producing a foil strip that forms a self-closing foil sheathing in a cable arrangement.

### BACKGROUND

Cable arrangements generally comprise at least one cable core which is provided for transmitting information or energy and which is sheathed by an insulating material. The cable core can be, for example, an electrical conductor or an optical fiber. In order to protect the at least one cable core from stray radiation, the cable core and the insulating material surrounding it are conventionally surrounded by a cable shielding. The cable shielding forms an electrically conducting protective sheathing which protects the cable core against the emission and irradiation of electromagnetic waves and accordingly improves the electromagnetic compatibility thereof.

In cable shielding, a distinction is typically made between braided shields and foil shields. Braided shields are formed of wires joined together to form a braid, which are suitable in particular for shielding electromagnetic waves of relatively low frequencies. Foil shields, on the other hand, consist of a foil-like material which completely encloses the cable core and the insulating material and are preferably used for shielding electromagnetic waves of higher frequencies. Cable arrangements are known in which a braided shield and a foil shield are arranged in layers and together form the cable shielding.

Cable arrangements are further known in which a foil strip is wound onto at least one conductor to form a foil sheathing around the at least one conductor. Such a foil sheathing can perform different functions. For example, the foil sheathing can constitute a fixing means for fixing multiple conductors relative to one another. Alternatively or in addition, the foil sheathing can constitute an insulator and/or a foil shield around the at least one conductor.

When handling cable arrangements, for example in the termination of cable arrangements, it can be desirable that the foil sheathing does not become detached after a cable outer jacket and/or a braid has been removed. In other words, the foil sheathing should retain its position relative to the at least one conductor even after the cable sheath and/or the braid has been removed. Accordingly, cable arrangements are proposed in the prior art in which the foil sheathing is fixed by means of an adhesive or other fixing means.

### SUMMARY OF THE INVENTION

The object underlying the invention is to provide a cable arrangement comprising a conductor and a foil sheathing enclosing the conductor, which cable arrangement has a simple structure as compared to known cable arrangements and reliably prevents the foil sheathing from being detached from the conductor. A further object underlying the invention is to provide a method and a tool for producing such a foil sheathing in the cable arrangement.

These objects are achieved by a method for producing a self-closing foil sheathing in a cable arrangement having the features of claim 1, a cable arrangement comprising such a foil sheathing having the features of claim 13, and a shaping tool for producing such a foil sheathing having the features according to claim 14.

A method for producing a self-closing foil sheathing which is wound on at least one conductor of a cable arrangement is provided. In the present case, the term “self-closing” means a structural property of the foil sheathing of adopting and/or retaining the position wound around the conductor without the action of additional fixing means, such as, for example, an adhesive, a braid and/or a cable jacket.

Within the meaning of the disclosure, the at least one conductor of the cable arrangement can describe, for example, a single conductor, multiple single conductors and/or a bunch of conductors. A conductor can accordingly describe at least one cable core or a structure comprising at least one cable core and an insulator surrounding the cable core.

The method can be used in the production of different cable arrangements. Preferably, the method is used in the production of cable arrangements which comprise a conductor having a foil sheathing enclosing the conductor in the longitudinal direction. In the present case, a foil sheathing means a layer of a foil-like material that is arranged around the conductor in its longitudinal direction and preferably encloses it. Depending on the function to be performed by the foil sheathing, the foil-like material can comprise a conducting material, for example a metallic material, or a non-conducting material, for example a plastics material.

For example, a foil sheathing in a STP (shielded twisted pair) cable can be produced by means of the method. STP cables typically comprise multiple single conductors with a copper conductor and an insulator surrounding it, which are stranded in pairs and shielded by means of a foil shield. More specifically, a foil sheathing can be produced by means of the method around each of the conductor pairs comprised in the STP cable. The foil sheathing can comprise an electrically conducting material and thus constitute the foil shield around the conductor pairs.

The method comprises a step of providing a resiliently deformable foil strip which in an unloaded or exposed state is curved in a plane of the foil strip. In the present case, an unloaded state means a state of the foil strip in which it is not resiliently deformed. In contrast, an exposed state of the foil strip means a state in which the foil strip is not in contact with the conductor that is to be wrapped or another component.

In a further step of the method, the foil strip is wound onto the at least one conductor in order to form the foil sheathing enclosing the at least one conductor, wherein the foil strip forming the foil sheathing, in a state in which it is wound on the conductor, is resiliently deformed radially outwards and thus radially loaded in the direction of the conductor. In other words, in the state in which it is wound on the conductor, the foil sheathing is acted upon by a spring force induced by the resilient deflection or deformation thereof. This spring force has the effect of pressing the foil sheathing against the conductor so that it is held in a self-closing manner on the conductor in the wound position.

By means of a foil sheathing produced around the conductor in this manner it can be ensured that the foil sheathing also does not automatically become detached, or unstranded, after the wrapped conductor has been exposed, that is to say after a cable jacket and/or braid enclosing the foil sheathing has been removed. In comparison to known cable arrangements in which, for example, the foil sheathing is fixed by means of an adhesive, additional fixing means for fastening the foil sheathing to the conductor are no longer required. Accordingly, it is possible by means of the method to produce cable arrangements which have a simple structure because, apart from the self-closing foil sheathing, no additional fixing means are required. Furthermore, a foil sheathing produced in this manner can be removed from the conductor without being damaged. In other words, a foil strip detached from the conductor can be wound onto a conductor again and is thus reusable.

The resiliently deformable foil strip provided in the method preferably forms a tubular body in the unloaded or exposed state. In the present case, a tubular body means an elongate hollow body, the lateral surface of which is formed by the foil strip. The tubular body preferably has a substantially closed lateral surface. The lateral surface is preferably formed by the foil strip in a state in which it is arranged spirally. Alternatively, the foil strip can be wound longitudinally for this purpose. In other words, the foil strip overlaps at least in portions, wherein layers arranged above one another are not offset relative to one another in a longitudinal direction of the tubular body so formed. A cross-section of the tubular body preferably has a substantially circular, elliptical or polygonal outer contour.

In cross-section, the tubular body preferably has a smaller diameter as compared to the at least one conductor. It can thus be ensured that, in the state in which the foil strip is wound on the conductor, the foil strip is resiliently deformed as compared to the unloaded or exposed state and a holding force induced by that deformation thus acts on the foil sheathing formed by the foil strip. More specifically, a largest diameter of the tubular body can be smaller than a smallest diameter of the conductor that is to be wrapped.

The foil strip curved in its plane preferably has a single curve in its unloaded or exposed state. In other words, a surface of the foil strip in the unloaded or exposed state can have a first principal curve k₁ in a first direction of curvature with the value 0. In contrast, a second principal curve k₂ of the surface of the foil strip in a second direction of curvature can have a value k₂ greater than 0. The second direction of curvature of the second principal curve is preferably perpendicular to the first direction of curvature of the first principal curve. Preferably, the foil strip in the unloaded or exposed state has a value k₂ which is greater than 2/D_{L}, wherein D_{L} describes the diameter of the conductor that is to be wrapped. In other words, in the second principal direction of curvature, the foil strip has a more pronounced curve, that is to say a curve with a smaller radius of curvature, compared to the conductor. By means of this form of the foil strip, resilient deformation and the holding force on the foil strip induced thereby can be ensured in the wound state.

Alternatively or in addition, the foil strip can have a double curve in the plane. In other words, in the unloaded or exposed state of the foil strip, a surface of the foil strip has a first and a second principal curve each with a value other than 0, preferably greater than 0.

In a further development, the foil strip can be so provided that a portion of the foil strip that is to be wound on the conductor has a substantially constant curve in its unloaded or exposed state. More specifically, the portion can have throughout a curve in its plane along the same axis of curvature or in the same direction of curvature and be provided with a substantially constant radius of curvature. In this manner it can be ensured that a uniform holding force is applied to the foil sheathing.

As described hereinbefore, the foil sheathing to be produced by means of the method can perform different functions within the cable arrangement. For example, the foil sheathing can be in the form of a foil shield. For this purpose, the foil sheathing can comprise an electrically conducting material. Alternatively or in addition, the foil sheathing can constitute a fixing means, for example in order to fix two or more conductors relative to one another. Alternatively or in addition, the foil sheathing can form an insulator arranged around a cable core. For this purpose, the foil sheathing can comprise an electrically non-conducting material, such as, for example, a plastics material. The foil strip provided in the method can accordingly comprise a plastics material, in particular polypropylene or polyethylene terephthalate.

In a further development, the foil strip can be in multilayer form and comprise a first layer of a plastics material, in particular polypropylene or polyethylene terephthalate, and a second layer of a metallic material, in particular aluminum. The first layer can thus form an insulator layer, which is electrically non-conducting. The second layer can be an electrically conducting layer and thus form a foil shield of the conductor.

In the method, the provision of the foil strip curved in its plane can be carried out by a step of plastic deformation of a foil strip pre-product. In an unloaded or exposed state, the foil strip pre-product preferably has a smaller or no curve in the plane as compared to the foil strip. The plastic deformation of the foil strip pre-product is preferably carried out in such a manner that the portion of the foil strip pre-product that is to be wound on the conductor is moved with a face that is to be placed on the conductor over a shaping edge of a shaping tool. The shaping edge of the shaping tool is preferably in the form of a sharp edge. For example, the shaping edge can have an edge angle of 60°. The edge angle can further have an angle between 90° and 10°. Furthermore, the shaping edge has an edge radius which is smaller than 1 mm. For example, the edge radius can have a value between 1 μm and 100 μm.

By plastically deforming the foil strip pre-product by moving it along a shaping edge, the provision of the foil strip curved in its plane can be carried out in a continuous method step. For example, the movement of the foil strip pre-product along the shaping edge can be carried out immediately before the foil strip is wound. The basic construction of a manufacturing tool for winding a foil strip onto a conductor is known to the person skilled in the art from the prior art and is not described in detail in the disclosure. Such a manufacturing tool can be modified on the basis of the present invention with a shaping tool described hereinbefore. In this manner, a method for producing the self-closing foil sheathing can be implemented with a reduced outlay in a continuous method known from the prior art for winding a foil strip.

The step of plastic deformation of the foil strip pre-product can be carried out in such a manner that the foil strip pre-product is subjected to a normal force acting in the direction of the shaping edge. The normal force acting on the foil strip pre-product in the direction of the shaping edge can be adjusted in dependence on the curve that is to be formed in the plane of the foil strip, in particular in dependence on a radius of curvature of the curve that is to be formed. In particular, the normal force acting on the foil strip pre-product can be variably adjusted in the method. In other words, the normal force can be adjusted according to the desired degree of curvature in the plane of the foil strip. In order to form a more pronounced curve in the plane of the foil strip, the normal force on the foil strip pre-product in the region of the shaping edge can be increased.

For establishing a desired curve in the plane of the foil strip, it can alternatively or additionally be provided that the geometric form of the shaping edge is correspondingly adapted. In particular, the edge radius and/or the edge angle of the shaping edge can be correspondingly adapted. The shaping edge can be a linear shaping edge. The linear shaping edge can be provided for producing a single curve in the plane of the foil strip, in particular a curve about an axis of curvature parallel to the shaping edge. Alternatively, the shaping edge can have a bent form. Such a shaping edge can be provided for producing a double curve in the plane of the foil strip. For example, it is thus possible to produce a curve in the plane of the foil strip with a first direction of curvature parallel to a direction of extension of the shaping edge and a second direction of curvature transverse to the first direction of curvature.

In a further development it can be provided that the shaping edge of the shaping tool can be variably adjusted. For example, the shaping tool can have multiple different shaping edges, wherein the foil strip pre-product can selectively be moved over one of the multiple shaping edges in the method.

The step of plastic deformation of the foil strip pre-product can be carried out in such a manner that the foil strip pre-product is moved relative to the shaping edge in such a manner that an angle between the shaping edge and a direction of movement of the foil strip pre-product at the shaping edge has a value between 90° and 20°, preferably 90° or 45°. The angle between the shaping edge and the direction of movement of the foil strip pre-product on movement thereof over the shaping edge thereby influences the degree of curvature formed in the foil strip, in particular the direction of curvature relative to the foil strip. If the angle between the shaping edge and the direction of movement of the foil strip pre-product is set at 90° in the step of plastic deformation, a foil strip that is wound longitudinally in the unloaded or exposed state can be provided, wherein layers arranged above one another are not offset relative to one another in a longitudinal direction of the tubular body so formed. A foil strip produced in that manner is not in spiral form in the unloaded or exposed state. If, on the other hand, the angle between the shaping edge and the direction of movement of the foil strip pre-product is set at 90°, a foil strip which, owing to its curvature, constitutes a spiral-shaped body in the unloaded or exposed state can be produced.

The step of plastic deformation of the foil strip pre-product is preferably carried out in such a manner that the angle between the shaping edge and the direction of movement of the foil strip pre-product at the shaping edge can be variably adjusted in dependence on the curve that is to be formed in the plane of the foil strip pre-product, in particular in dependence on a direction of curvature relative to the foil strip that is to be formed.

Adjustment of the foil strip can be carried out in particular in dependence on a pitch angle of the foil strip in the state in which it is wound on the conductor. The angle between the shaping edge and the direction of movement of the foil strip pre-product is preferably so adjusted that it corresponds substantially to the pitch angle of the foil strip in the state in which it is wound on the conductor.

The step of winding the foil strip onto the conductor can be carried out in such a manner that the foil strip is wound on the conductor longitudinally or spirally. A longitudinally wound foil strip has a pitch angle of 0° in the wound state. In the case where the foil strip is wound longitudinally, there is preferably provided a foil strip which, in the unloaded or exposed state, comprises layers arranged above one another which are not offset relative to one another in the longitudinal direction. A spirally wound foil strip has a pitch angle other than 0 and preferably a pitch angle of 45°. In order to produce a closed foil sheathing, the step of winding the foil strip onto the conductor can be carried out in such a manner that edge regions of the foil strip overlap in the wound state.

There is further provided a cable arrangement which comprises at least one conductor and a self-closing foil sheathing wound around the conductor. The foil sheathing is formed by a foil strip which, in a state in which it is wound on the conductor, is resiliently deformed radially outwards and thus radially loaded in the direction of the conductor. The foil sheathing is preferably a foil sheathing produced by means of the preceding method.

There is further provided a shaping tool for producing a foil strip that forms a self-closing foil sheathing in a cable arrangement. The shaping tool has a base body with at least two shaping edges formed on the lateral surface thereof and is adapted selectively to position one of the shaping edges in such a manner that a foil strip pre-product can be moved over that shaping edge in order to produce the foil strip by means of plastic deformation of the foil strip pre-product, which foil strip is elastically deformable and, in an unloaded or exposed state, curved in a plane of the foil strip.

The base body is preferably prism-shaped and has at least three shaping edges formed on the lateral surface thereof. For example, the prism-shaped base body can be provided in the form of a straight prism having a base in the form of a polygon, in particular in the form of an equilateral triangle.

Although some aspects and features have been described only in relation to the method for producing a self-closing foil sheathing wound on at least one conductor of a cable arrangement, those aspects and features can apply correspondingly to the cable arrangement and/or the shaping tool as well as to further developments thereof.

### BRIEF DESCRIPTION OF THE DRAWINGS

The present disclosure is to be explained further by means of figures. These figures show, in schematic form:

FIGS. 1 to 4 a method for producing a self-closing foil sheathing wound on at least one conductor of a cable arrangement,

FIG. 5 a cable arrangement comprising a self-closing foil sheathing, and

FIG. 6 a shaping tool for producing a self-closing foil sheathing.

### DETAILED DESCRIPTION

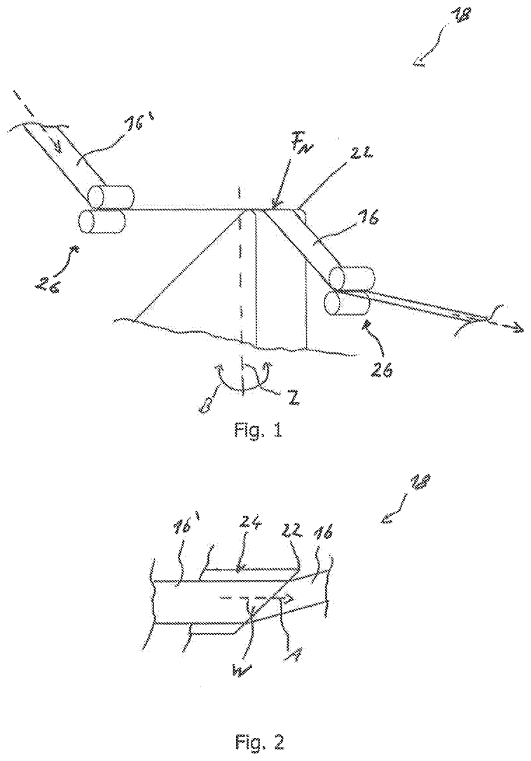

A method for producing a self-closing foil sheathing 14 wound on at least one conductor 10 of a cable arrangement 12, as shown in FIG. 4, is described hereinbelow with reference to FIGS. 1 to 4.

In a first step of the method, a resiliently deformable foil strip 16 which in an unloaded or exposed state is curved in a plane of the foil strip 16 is provided. FIGS. 1 and 2 illustrate this method step, wherein FIG. 1 is a perspective view of an apparatus 18 for providing the foil strip 16 and FIG. 2 is a plan view of the apparatus shown in FIG. 1.

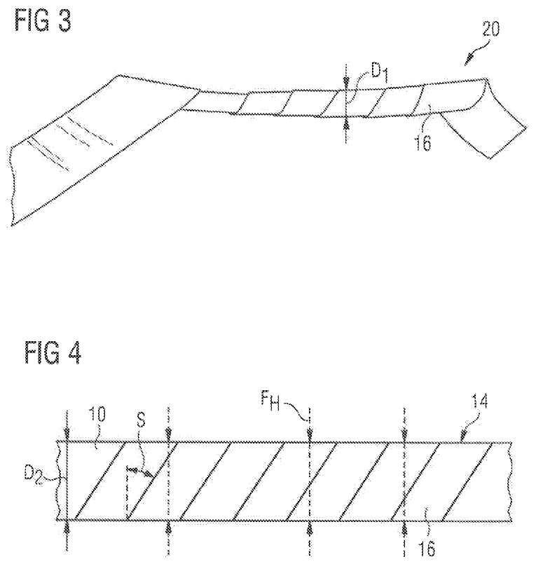

FIG. 3 shows a foil strip 16 provided by means of the apparatus 18 in an exposed state. In this state, the foil strip 16 forms a tubular body 20. More specifically, the foil strip 16 in the exposed state is arranged in the form of a spiral, wherein the foil strip 16 forms a lateral surface of the tubular body 20. The cross-section of the tubular body 20 is substantially provided with a circular outer contour.

The tubular body 20 has, in cross-section, a smaller diameter compared to the at least one conductor 10. More specifically, the tubular base body 20 has a substantially constant outside diameter D₁ which is smaller than an outside diameter D₂ of the conductor 10. It can thus be ensured that, when the foil strip 16 is in the state wound on the conductor 10, as shown in FIG. 4, the foil strip 16 is resiliently deformed as compared to the unloaded or exposed state, and a holding force F_{H} induced by that deformation thus acts on the foil sheathing 14 formed by the foil strip 16.

The method step of providing the foil strip 16 will be described in greater detail hereinbelow with reference to FIGS. 1 and 2. The provision of the foil strip 16 is carried out by a step of plastic deformation of a foil strip pre-product 16′. The plastic deformation of the foil strip pre-product 16′ is carried out in such a manner that a portion of the foil strip pre-product 16′ that is to be wound on the conductor 10 is moved with a face that is to be placed on the conductor over a shaping edge 22 of a shaping tool 24. The shaping edge 22 of the shaping tool 24 is in the form of a sharp edge and has an edge angle of 60°.

The method step of plastic deformation of the foil strip pre-product 16′ performed by means of the apparatus 18 is carried out continuously. For this purpose, the foil strip pre-product 16′ is unwound from a supply roll, not shown here, and moved over the shaping edge 22 by means of deflecting rollers 26. The foil strip pre-product 16′ is thereby subjected to a normal force F_{N} acting in the direction of the shaping edge 22. The normal force F_{N} acting on the foil strip pre-product 16′ in the direction of the shaping edge 22 is variably adjustable in dependence on the curve that is to be formed in the plane of the foil strip 16, in particular in dependence on a radius of curvature of the curve that is to be formed. This can be carried out, for example, in that the shaping tool 24 is moved upwards or downwards along its vertical axis Z relative to the deflecting rollers 26.

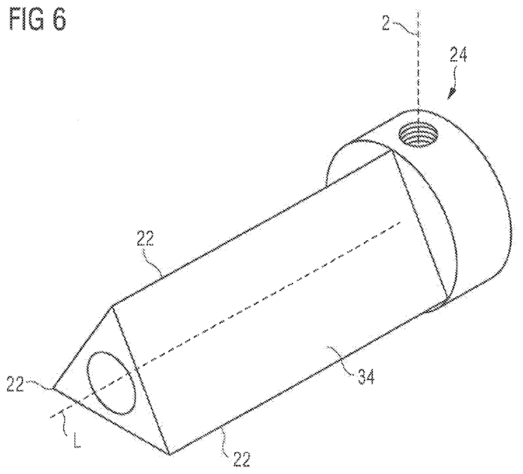

For adjusting a desired curve in the plane of the foil strip 16, it can additionally be provided that the geometric form of the shaping edge 22 is adjustable. In particular, an edge radius and/or an edge angle of the shaping edge 22 can correspondingly be adjusted. For this purpose, a shaping tool 24 having multiple shaping edges 22 can be provided, as shown in FIG. 6, wherein the foil strip pre-product 16′ is selectively moved over one of the multiple edges 22. In the present case, the shaping tool 24 has a linear shaping edge 22, which is adapted in particular for producing a single curve in the plane of the foil strip 16. In a further embodiment, the shaping tool 24 has different radii at the multiple, for example three, edges 22. One shaping tool can thus be used for different foils on which the different radii are established.

The step of plastic deformation of the foil strip pre-product 16′ is carried out in such a manner that the foil strip pre-product 16′ is moved relative to the shaping edge 22 in such a manner that an angle W between the shaping edge 22 and a direction of movement A of the foil strip pre-product 16′ at the shaping edge 22 has a value of approximately 45°. An angle of approximately 45° is advantageous in view of the frequency range often present in such conductors. In the apparatus 18 shown in the present case, the angle W between the shaping edge 22 and the direction of movement A of the foil strip pre-product 16′ is variably adjustable in dependence on the curve that is to be formed in the plane of the foil strip 16, in particular in dependence on a direction of curvature relative to the foil strip 16 that is to be formed. This can be achieved by a pivoting movement of the shaping tool 24 about its vertical axis Z relative to the foil strip pre-product 16′, as indicated in FIG. 1 by an arrow B. The adjustment of the angle W is carried out in particular in dependence on a pitch angle S of the foil strip 16 in the state in which it is wound on the conductor 10, as shown in FIG. 4. More specifically, the angle W between the shaping edge 22 and the direction of movement A of the foil strip pre-product 16′ is so adjusted that it corresponds substantially to the pitch angle S of the foil strip 16′ in the state in which it is wound on the conductor 106.

The method step shown in FIGS. 1 and 2 makes it possible for the portion of the foil strip 16 that is to be wound on the conductor 10 to have a substantially constant curve in its exposed state. In other words, as shown in FIG. 3, the portion of the foil strip 16 that is to be applied is provided throughout with a curve in its plane along the same axis of curvature and with a substantially constant radius of curvature. The axis of curvature here corresponds to the longitudinal axis of the tubular body 20.

In the method shown here, the foil strip 16, and accordingly the foil strip pre-product 16′, is in multilayer form, wherein a first layer comprises a plastics material, in particular polyethylene terephthalate, and a second layer comprises a metallic material, in particular aluminum. The step of plastic deformation of the foil strip pre-product 16′ is thereby performed in such a manner that the first layer is guided over the shaping edge 22 in contact therewith.

In a further step of the method, the foil strip 16 provided is wound onto the at least one conductor 10 in order to form the foil sheathing 14 enclosing the at least one conductor. This is carried out in such a manner that the foil strip 16 forming the foil sheathing 14, in a state in which it is wound on the conductor 10, is resiliently deformed radially outwards and thus radially loaded in the direction of the conductor 10. In other words, in the state wound on the conductor 10, the foil sheathing 14 is acted upon by the holding force F_{H} induced by the resilient deflection or deformation thereof. This has the effect of pressing the foil sheathing 14 against the conductor 10 so that it is held in a self-closing manner on the conductor 10 in the wound position.

The step of winding the foil strip 16 onto the conductor 10 is carried out in such a manner that the foil strip 16 is spirally wound on the conductor 10. The wound foil strip has a pitch angle of approximately 45°. In order to produce a closed foil sheathing 14, winding is further carried out in such a manner that edge regions of the foil strip 16 overlap in the wound state.

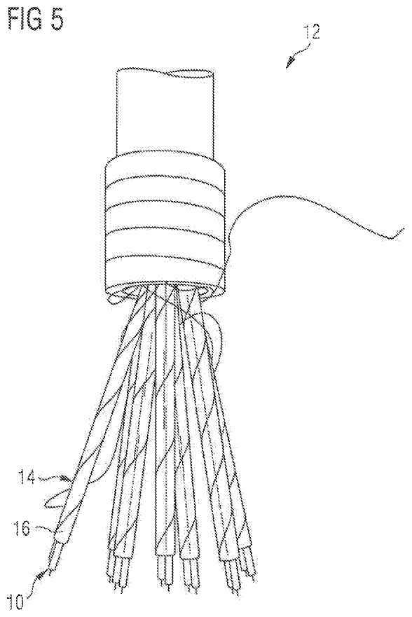

FIG. 5 shows a cable arrangement 12 in the form of a STP (shielded twisted pair) cable with exposed conductor strands. The cable arrangement 10 comprises multiple single conductors 10, which are stranded in pairs and shielded by means of a foil shield. The foil shield around in each case two stranded single conductors 10 has been produced by means of the method described hereinbefore. The foil shield is thereby formed by the foil strip 16 constituting the self-closing foil sheathing 14. In the wound state, the foil strip 16 is resiliently deformed radially outwards and thus radially loaded in the direction of the single conductors 10.

FIG. 6 shows a shaping tool 24 for producing the foil strip 16 forming the self-closing foil sheathing 14. The shaping tool 24 has a prism-shaped base body 34 with three shaping edges 22 formed on the lateral surface thereof. The prism-shaped base body 34 comprises a base in the form of an equilateral triangle. The shaping tool is adapted selectively to position one of the shaping edges 22 in such a manner that the foil strip pre-product 16′ can be moved over that shaping edge in order to produce the foil strip 16 by means of plastic deformation of the foil strip pre-product 16′. The foil strip 16 so produced is resiliently deformable and, in an unloaded or exposed state, is curved in a plane of the foil strip 16. The shaping tool 24 shown here can be used in the method step shown in FIGS. 1 and 2. In order selectively to position one of the shaping edges relative to the foil strip pre-product 16′ that is to be deformed, the shaping tool 24 is preferably adapted to be pivoted about its longitudinal axis L.

1. A method for producing a self-closing foil sheathing which is wound on at least one conductor of a cable arrangement, comprising the steps:
providing a resiliently deformable foil strip which in an unloaded or exposed state is curved in a plane of the foil strip; and
winding the foil strip onto the conductor in order to form the foil sheathing enclosing the conductor, wherein the foil strip forming the foil sheathing, in a state in which it is wound on the conductor, is resiliently deformed radially outwards and thus radially loaded in the direction of the conductor.

2. The method as claimed in claim 1, in which the resiliently deformable foil strip in the unloaded or exposed state forms a tubular body which has a smaller diameter as compared to the conductor.

3. The method as claimed in claim 1, in which the foil strip comprises a plastics material, in particular polyethylene terephthalate or polypropylene.

4. The method as claimed in claim 1, in which the foil strip is in multilayer form and comprises a first insulating layer of a plastics material, in particular polyethylene terephthalate or polypropylene, and a second conducting layer of a metallic material, in particular aluminum.

5. The method as claimed in claim 1, which further comprises a step of plastic deformation of a foil strip pre-product to produce the foil strip curved in its plane, in that a portion of the foil strip pre-product that is to be wound on the at least one conductor is moved with a face that is to be placed on the conductor over a shaping edge of a shaping tool.

6. The method as claimed in claim 5, wherein, in the step of plastic deformation of the foil strip pre-product, a normal force acting on the foil strip pre-product in the direction of the shaping edge is applied.

7. The method as claimed in claim 6, wherein the normal force acting on the foil strip pre-product in the direction of the shaping edge is variably adjustable in dependence on the curve that is to be formed in the plane of the foil strip, in particular in dependence on a radius of curvature that is to be formed.

8. The method as claimed in claim 5, wherein an edge angle and/or an edge radius of the shaping edge of the shaping tool is variably adjustable in dependence on the curve that is to be formed in the plane of the foil strip, in particular in dependence on a radius of curvature that is to be formed.

9. The method as claimed in claim 5, in which, in the step of plastic deformation of the foil strip pre-product, the foil strip pre-product is moved relative to the shaping edge in such a manner that an angle between the shaping edge and a direction of movement of the foil strip pre-product at the shaping edge has a value between 90° and 20°, preferably 90° or 45°.

10. The method as claimed in claim 9, wherein the angle between the shaping edge and the direction of movement of the foil strip pre-product at the shaping edge is variably adjustable in dependence on the curve that is to be formed in the plane of the foil strip, in particular in dependence on a direction of curvature that is to be formed.

11. The method as claimed in claim 9, wherein the angle between the shaping edge and the direction of movement of the foil strip pre-product at the shaping edge is so adjusted that it corresponds to a pitch angle of the foil strip in the state in which it is wound on the conductor.

12. The method as claimed in claim 1, wherein the step of winding the foil strip on the conductor is carried out in such a manner that the foil strip is wound on the conductor longitudinally or spirally, and wherein in particular edge regions of the foil strip overlap in the wound state.

13. A cable arrangement having at least one conductor and a self-closing foil sheathing wound around the conductor, wherein a foil strip forming the foil sheathing, in a state in which it is wound on the conductor, is resiliently deformed radially outwards and thus radially loaded in the direction of the conductor.

14. A shaping tool for producing a foil strip forming a self-closing foil sheathing in a cable arrangement, which shaping tool has a base body with at least two shaping edges formed on its lateral surface and is adapted selectively to position one of the shaping edges in such a manner that a foil strip pre-product can be moved over that shaping edge in order to produce the foil strip by means of plastic deformation of the foil strip pre-product, wherein the foil strip is resiliently deformable and, in an unloaded or exposed state, is curved in a plane of the foil strip.

15. The shaping tool as claimed in claim 14, wherein the base body is prism-shaped and has at least three shaping edges formed on the lateral surface thereof.
